(19) United States
(12) Patent Application Publication
(10) Pub. No.: US 2024/0385349 A1
(43) Pub. Date: Nov. 21, 2024

(54) Method and Device for Acquiring Precipitation Data

(71) Applicant: Metek Meteorologische Messtechnik GmbH, Elmshorn (DE)

(72) Inventor: Gerhard Peters, Hamburg (DE)

(21) Appl. No.: 18/696,405

(22) PCT Filed: Oct. 1, 2022
(86) PCT No.: PCT/EP2022/077420

§ 371 Date: Mar. 28, 2024

(30) Foreign Application Priority Data
Oct. 1, 2021 (DE) 10 2021 125 579.1

(51) Int. Cl. G01W 1/14

(52) U.S. Cl. CPC G01W 1/14

(57) ABSTRACT

A method as well as a device for recording precipitation events are described. Here, sound transducers for emitting and receiving ultrasonic signals are provided, which, de-pending on a property of these ultrasonic signals, generate a measurement signal, which is evaluated to determine at least one atmospheric parameter. The solution described is characterized by the fact that a precipitation event is detected on the basis of the evaluation of the measurement signals generated by the sound transducers.

### CROSS REFERENCE TO RELATED APPLICATIONS

This application is the U.S. national stage of International Application No. PCT/EP2022/077420, filed on 2022 Oct. 1. The international application claims the priority of DE 102021125579.1 filed on 2021 Oct. 1; all applications are incorporated by reference herein in their entirety.

### BACKGROUND

The invention relates to a method as well as a device for recording precipitation events. Here, sound transducers are arranged on opposite sides of a measuring section, each of which alternately emits ultrasonic waves during a transmission period at least in certain areas along the measuring section, so that the non-transmitting sound transducer at least partially receives the emitted ultrasonic waves. During receipt of the ultrasonic waves, the sound transducers generate measurement signals depending on a property of the received ultrasonic waves, which are transmitted, via a data transmission path, to an evaluation unit, in which information about at least one atmospheric parameter is generated on the basis of a frequency of the measurement signals.

Various measuring instruments are known from the state of the art, with which the local measurement of the velocity of a flow field, in particular the wind velocity, is undertaken. A special type of wind measuring devices or so-called anemometers, resp., are ultrasonic anemometers. Ultrasonic anemometers, which have been known for a long time, use the principle of measuring the transit time of the sound waves between transmitter and receiver. This utilizes the fact that sound waves are carried along by the medium in which they propagate, so that the transit time of signals over a measuring section with a fixed length depends on the flow through the measuring section. Using sound waves of high frequency or high bandwidth, resp., transit times can be determined particularly accurately, so that high-frequency sound waves are preferably used in measuring sections with a short distance. Since the velocity of sound depends on both air temperature and air humidity, transit times are usually determined in both directions, i.e. bidirectionally. The so-called virtual temperature can also be calculated from the sum of these two transit times. Known ultrasonic anemometers usually have several measuring sections between the individual ultrasonic transmitters and receivers, via which the velocity of sound is measured in various spatial directions. An electronic measuring system then calculates the horizontal and vertical wind velocities from the resulting measured values.

Such an ultrasonic anemometer is known from DE 689 01 800 T2. With the ultrasonic anemometer described, the transit times of sound waves in various measuring sections between the individual ultrasonic transducers are recorded and evaluated, wherein the ultrasonic transducers are arranged such that they define at least three different ultrasound transmission paths in the air. Furthermore, an electronic measuring system is provided, so that on the basis of the propagation time measurement of the ultrasonic waves along the various paths the wind direction as well as the wind velocity are determined taking into account the measured propagation times.

Furthermore, DE 10 2015 004 408 A1 describes an ultrasonic anemometer having at least two sound transducers, between which a measuring section is arranged, wherein the respectively extending measuring sections can be arranged differently in space. It is essential for the technical solution described that surfaces of the sound transducers are inclined relative to a vertical, so that moisture, snow or other particles can slide off the respective surface.

In addition, sensors are often used in meteorological instrumentation, that must be protected against precipitation such as rain and snow or whose signals cannot be evaluated in case of such precipitation events. Furthermore, knowledge of the times or periods, in which precipitation events occur, is often necessary for the analysis and evaluation of meteorological measurement series. For this purpose, precipitation detectors of various designs are used, such as a rain radar as known from DE 103 05 139 B4.

### SUMMARY

A method as well as a device for recording precipitation events are described. Here, sound transducers for emitting and receiving ultrasonic signals are provided, which, depending on a property of these ultrasonic signals, generate a measurement signal, which is evaluated to determine at least one atmospheric parameter.

The solution described is characterized by the fact that a precipitation event is detected on the basis of the evaluation of the measurement signals generated by the sound transducers.

### DETAILED DESCRIPTION

Based on the solutions known from the state of the art, the object generally is to minimize the effort for meteorological measurements with regard to the required measuring instruments as well as for the required data evaluation, and yet to be able to detect precipitation events with high reliability. In this context, the invention is based on the object of specifying a measuring device as well as a measuring method, so that the measurement of at least one component of the wind velocity and/or the wind direction and also the detection of a precipitation event is possible with high accuracy and reliability without the need for additional instrumentation. The solution to be specified should therefore make it possible to determine the time and duration of a precipitation event, such as rain or snowfall, as accurately as possible and make it available for measuring meteorological parameters in a relatively simple manner. In that, it would be advantageous, if the signal and data evaluation for recording a precipitation event could be realized as simply as possible.

The object described above is solved by a method according to claim 1 as well as a device according to claim 12. Advantageous embodiments of the invention are the subject of the dependent claims and are explained in more detail in the following description with partial reference to figures.

The invention first relates to a method for recording precipitation events, in which two sound transducers arranged on opposite sides of a measuring section each alternately emit ultrasonic waves during a transmission period at least in certain areas along the measuring section in such a way that, in a first transmission period, a first of the sound transducers emits ultrasonic waves, while the opposite second sound transducer at least partially receives the emitted ultrasonic waves, and in which, in at least one second transmission period, the second sound transducer emits ultrasonic waves, while the first transducer at least partially receives the emitted ultrasonic waves. The sound transducers each generate at least one measurement signal during receipt of the ultrasonic waves depending on a property of the received ultrasonic waves or sound signals, resp., which measurement signal is transmitted via a data transmission path, which can be wireless or wired, to an evaluation unit, in which information about at least one atmospheric parameter is generated on the basis of a property of the measurement signals. According to the invention, the method has been further developed in such a way that the evaluation unit detects and evaluates changes in the frequency of the measurement signals generated by the sound transducers, records a magnitude and a response curve of the frequencies during the changes in frequency and, depending on the magnitude of the change in frequency as well as a comparison of the frequency response curves during the change in frequency, i.e., the change in frequency within a measuring period, detects a precipitation event and outputs information about the detection of the precipitation event. While with the known systems for recording atmospheric properties, in particular wind velocity and/or direction, the measurement signal is only evaluated with regard to a transit time of the sound waves between transmitter and receiver, according to the invention, there is a special evaluation of frequency properties of the measurement signal. Here, the additional evaluation of special frequency properties, in particular changes in frequency, is used to be able to provide information about precipitation events.

It is thus essential that specific changes in the frequency of the measurement signal or of a received signal, resp., that is generated by the forced oscillation of a sound transducer operating as a receiver, caused by the impinging sound waves, are detected. Here, in particular, the magnitude of a change in frequency as well as the temporal response curve of a change in frequency, and thus the development of a change in frequency within a measurement period, are evaluated. According to the invention, it has been recognized that the two aforementioned properties of a change in the frequency of the measurement signal can be used in a suitable manner to reliably detect or record, resp., a precipitation event, namely the time of its start, its end and thus the time period.

According to the invention, it has thus been recognized that certain changes in frequency and in particular in the response curve or the temporal change of a change in frequency can be used to detect precipitation events. For this purpose, the evaluation unit advantageously receives the at least one measurement signal, amplifies it and converts it into a digital signal for further evaluation. The change in the frequency of the measurement signal is presumably due to the fact that a water layer forms on at least one of the sound transducers, in particular the lower one, or a drop of water hangs from the upper sound transducer. The oscillating mass of the respective sound transducer is increased by the water layer or the attached water droplet, wherein the restoring forces remain at least approximately the same. This lowers the resonant frequency of the sound transducer, so that ultimately a similar effect can be assumed as with the variation in pitch when touching glasses of water filled at different levels. Since the mean frequencies are subject to other influencing factors in addition to precipitation, such as temperature, they are not suitable for reliable detection of precipitation events. Therefore, according to a particular embodiment of the invention, the frequencies of the measurement signals themselves are not primarily used for precipitation detection, but the fine structures of their temporal change. Preferably, standard deviations of the frequencies are at least partially determined during the evaluation and used as a basis for the detection of precipitation types.

According to a particular embodiment of the invention, it is provided that, upon evaluation of the measurement signals, the occurrence of a precipitation event is detected, if a limit value defined for the magnitude of the change in frequency is exceeded and the response curves, i.e. the temporal changes of the changes in frequency, of the measurement signals generated by the opposite sound transducers are at least approximately identical, synchronous and/or mean gradients of the temporal changes in frequency are at least approximately identical. According to this embodiment, a specific type of change in frequency is detected and at the same time a comparison of the measurement signals generated at opposite sound transducers is performed. In this case, a precipitation event is detected, i.e. the presence of a precipitation event is inferred, as soon as, on the one hand, the magnitude of the change in frequency of the measurement signals has exceeded a defined limit value and, on the other hand, the response curves of the changes in frequency of the measurement signals generated by opposite sound transducers exhibit a certain property, for example the mean gradient of the changes in frequency has a specific value or specific values.

It is also conceivable that, upon evaluation of the measurement signals, the frequencies of the measurement signals generated by the opposite sound transducers within a measuring period are at least temporarily added and/or mean values are formed therefrom. In this case, at least one value, preferably a plurality of values lying within a measuring period, of the frequency of the measurement signals is thus respectively added and/or at least one mean value is formed therefrom. In the previously described preferred evaluation of the measurement signals generated by oppositely arranged sound transducers, it is taken into account that the formation of a water layer on one of the two or on both sound transducers leads to a change in the frequencies of the generated measurement signals at both sound transducers. If only one of the two sound transducers has a water layer on its surface, the associated change in the natural frequency, at least as soon as this sound transducer assumes the function of a transmitter, also influences the vibration behavior of the opposite sound transducer, even if its surface is not wetted with water. In this context, it has been recognized that, when precipitation events occur, especially during rain, the changes in frequency of the measurement signals generated by the sound transducers are usually step-like or with pulse-like frequency jumps, wherein, upon evaluation of the measurement signals, it is preferably taken into account that changes in frequency can occur not only when precipitation events occur, but also in rain-free periods.

Therefore, in a particular further development of the invention, temperature fluctuations and/or effects due to the evaporation of water are taken into account when evaluating the frequencies of the measurement signals generated. Surprisingly, it was found in this respect that the changes in frequency of the measurement signals caused by the latter influencing factors are sluggish, i.e. that the response curve of a change in frequency thus changes relatively slowly. It is therefore advantageous to differentiate between these comparatively slow changes in frequency and the sudden and thus precipitation-induced, often rain-induced changes in frequency.

It was also found that rapid changes in the frequency of the measurement signals generated by the sound transducers can also be caused by turbulence in the atmosphere, and thus there is a general risk that turbulence-induced changes in frequency are confused with precipitation-induced changes in frequency. In order to further increase the reliability of precipitation detection, a special embodiment of the invention therefore provides for utilizing a significant difference between precipitation-induced and other rapid changes in frequency when evaluating the measurement signals generated by the sound transducers. In this case, it is taken into account that in the case of precipitation-induced changes in frequency, the changes in frequency of the sound transducers respectively arranged opposite each other are the same with high relative accuracy, i.e. the changes in frequency at both sound transducers either result in an increase or in a decrease in the frequency of the measurement signal respectively generated. In contrast, the changes in the frequencies of measurement signals generated by oppositely arranged sound transducers in periods without precipitation are of different magnitudes or even in opposite directions.

In order to be able to achieve a further increase in the accuracy of precipitation detection, a further embodiment of the invention provides the formation of mean values of the frequency of the measurement signals generated by the sound transducers over an averaging period, which preferably is 50 seconds, and the calculation of standard deviations related to this mean value.

In a further embodiment of the invention, it is perceivable that, upon evaluation of the frequencies of the measurement signals generated by opposite sound transducers,
a standard deviation σ for each of the measurement signals generated by opposite sound transducers,
a standard deviation σₘ of the mean frequency of the measurement signals generated by opposite sound transducers,
a standard deviation σ_{d} of half the difference in frequencies,
a quotient q formed from σ_{d} and σₘ, and
a precipitation indicator σᵣ determined taking into account the standard deviation σₘ as well as the aforementioned quotient q, in particular by quotient formation,
   are respectively determined, at least at times. In that, the following calculation rules are preferably used:
σ(f₁) and (f₂): standard deviations of the frequencies generated by oppositely arranged sound transducers;
σₘ=σ((f₁+f₂)/2)): standard deviation of the mean frequencies;
σ_{d}=σ((f₁−f₂/2)): standard deviation of half the difference in frequencies;
q=σ_{d}/σ_{d}: quotient;
σᵣ=σₘ/(10·q+0.5): precipitation indicator.

In this connection, a value of 0.5 is added to the denominator in the calculation rule for determining the precipitation indicator in accordance with the embodiment explained here, in order to prevent division by zero (0). It is particularly advantageous to use the magnitude of the precipitation indicator as the basis for deciding whether a precipitation event is present.

The standard deviations are advantageously calculated over a sliding timeframe ws. Slow changes in frequency, which extend over a longer period of time than fast ones, in particular over a significantly longer period of time than the defined timeframe ws, are thus suppressed and are not taken into account when evaluating the measurement signals for precipitation detection. These relatively slow changes in frequency can be caused, for example, by temperature changes in the environment or by a water layer still stationary on a sound transducer after the end of a precipitation event. Preferably, a measurement signal evaluation thus always takes place after the end of the sliding timeframe ws, and an independent sample is only then available. According to this embodiment, the length of the timeframe ws thus determines the temporal resolution of the measurements. Preferably, a period between 45 and 55 s, in particular 50 s, is selected as the duration of the timeframe ws.

A further particular embodiment of the invention provides the averaging of the frequencies of the measurement signals over a sliding averaging timeframe of a length wm and/or determining of at least one median value even before determining the standard deviations of the frequencies of the measurement signals generated by the opposite sound transducers, in order to at least reduce measured value noise. Preferably, a sliding averaging timeframe wm with a length of 45 to 55 s, in particular 50 s, is used.

By defining and using the sliding timeframe ws and the sliding averaging timeframe wm, a bandpass with the center frequency f_{mB}=2/(wm+ws) is advantageously defined.

In an advantageous manner, the measurement signals are evaluated such that a stable binary signal with the values 0 and 1 is generated, so that the binary signal can be used to clearly decide, whether a precipitation event is present or not.

Overall, it is important for the method according to the invention that a suitable value, such as a precipitation indicator is defined, on which a decision as to whether a precipitation event is present can be based. If a precipitation indicator is defined by determining the standard deviations of the measurement signal, as described above, a special further development of the invention provides that a precipitation event is detected, if the precipitation indicator is above a threshold value of 10-70 Hz, in particular above 60 Hz. The threshold is preferably selected depending on the respective embodiment of the ultrasonic anemometer. The threshold is advantageously determined empirically, as it can be assumed that it depends on the natural frequency and the magnitude of the sound transducers. The threshold value is preferably set to a value between 4 and 300 Hz, provided that the diameters of the sound transducers are between 8 and 15 mm.

A particular embodiment of the invention further provides that it is checked in a measuring interval, how often the precipitation indicator lies above the threshold value. In this case, the presence of a precipitation event is preferably concluded as soon as a precipitation indicator above the threshold value is determined for more than half of the measurements performed in the measuring interval.

Furthermore, it is advantageous to select a period of about one minute, in particular exactly one minute, for a measuring interval, in which 600 measurements are then performed. According to this embodiment, a measurement sequence with a frequency of 10 Hz is thus performed, but it is also conceivable to adapt this specifically to the properties of a measuring device.

Furthermore, it is advantageous, if the information about the presence of the precipitation event is stored in a memory over a period of 3-6 minutes, preferably for about 5 minutes, from detection of the precipitation event and/or is buffered in some other way.

The information about the presence of a precipitation event obtained in the evaluation unit on the basis of the evaluated measurement signals, for example in the form of a binary signal or another result signal, may exhibit interruptions during a precipitation event, which is due to the stochastic nature of the measurement signal. The comparatively small sensor surface of the sound transducers, which in the case of ultrasonic transducers is often less than 1 cm², is either hit or not hit by a precipitation particle, in particular a raindrop. For this reason, each value representing a precipitation event is preferably recorded during a storage timeframe, which preferably has a length of 3 to 6, in particular 5 minutes.

In addition to a method, the invention also relates to a device for recording precipitation events with at least two sound transducers, wherein such a device preferably is a so-called ultrasonic anemometer, which is frequently used to determine the wind velocity and wind direction and has at least two ultrasonic transducers, between which a measuring section extends. The device according to the invention thus has at least two sound transducers, between which a measuring section extends, wherein the sound transducers are adapted to each alternately emit sound waves along the measuring section or to receive sound waves coming from the measuring section and to generate a measurement signal. Furthermore, an evaluation unit is provided, which is connected to the sound transducers via a signal transmission path and generates information about at least one atmospheric parameter on the basis of a property of the at least one measurement signal, which is respectively generated by the sound transducers. Up to now, it has been customary to evaluate the measurement signal taking into account the transit time of a sound signal between two sound transducers. According to the invention, the device has been further developed in such a way that the evaluation unit is adapted to detect a precipitation event on the basis of a change in the frequencies of the measurement signals generated by opposite sound transducers, taking into account a magnitude of the changes in frequency of the measurement signals and a comparison of the response curve of the changes in frequency. Preferably, the changes in frequency of the measurement signals generated by the first and the second sound transducer are compared.

In a particular embodiment of the invention, the evaluation unit is adapted to detect the occurrence of a precipitation event as soon as a limit value defined for the magnitude of the change in frequency is exceeded and response curves of the changes in frequency, i.e. the temporal changes of the changes in frequency, of the measurement signals generated by the opposite sound transducers are identical, synchronous and/or mean gradients of the response curves of the changes in frequency are identical. Here, the evaluation unit is adapted such that the measurement signals respectively generated during a measuring period by the first sound transducer and by the second sound transducer arranged on the opposite side of the measuring section are compared with regard to the type or the response curve, resp., of the change in frequency. If the temporal changes in frequency are identical, synchronous and/or mean gradients of the response curves of the change in frequency are identical, the existence of a precipitation event is concluded and corresponding information is output, in particular in the form of a result signal, which preferably is a binary signal.

According to a further embodiment of the invention, it is provided that the limit value for the magnitude of the change in frequency taken into account in the evaluation unit is greater than 800 Hz, particularly preferably greater than 1 kHz, wherein this value is preferably recorded over a sliding averaging timeframe with a length of 45 to 55 s, preferably 50 s, and the values of the frequency of the measurement signals measured over the sliding averaging timeframe are averaged or a median value is formed, resp.

According to a particular embodiment of the invention, piezo sound transducers with a natural frequency of 58 KHz and a 3 dB bandwidth of about 6 kHz are used as sound transducers.

### BRIEF DESCRIPTION OF THE DRAWINGS

In the following, the invention will be explained in more detail, without limiting the general idea of the invention, by means of specific embodiments with reference to the figures. Therein:

FIG. 1: shows a 1-component ultrasonic anemometer with a vertical measuring section for recording a wind velocity;

FIG. 2: shows an exemplary representation of a measurement signal generated by a sound transducer;

FIG. 3: shows a representation of a response curve of the frequencies of the measurement signals generated by two oppositely arranged sound transducers over a period of 8 hours;

FIG. 4: shows a representation of the temporal response curve of the values of the precipitation indicator determined in the evaluation unit together with the rain rate recorded by means of the rain radar stated above;

FIG. 5: shows a representation of the binary signal indicating the detected precipitation results as well as the intensity and amount of rain recorded with the rain radar; as well as

FIG. 6: shows a representation of the binary signal indicating the detected precipitation results as well as the intensity and amount of rain recorded with the rain radar.

### DETAILED DESCRIPTION OF THE PREFERRED EMBODIMENTS

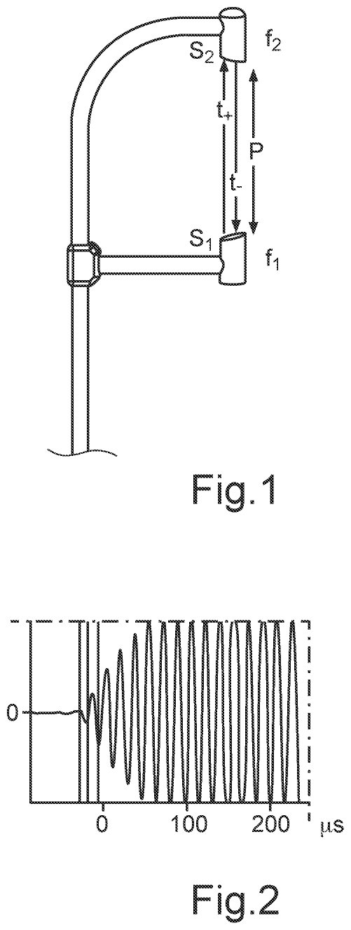

FIG. 1 shows a 1-component ultrasonic anemometer with a vertical measuring section for recording a wind velocity. A vertical measuring section extends between a first and an oppositely arranged second sound transducer. Even though the invention is explained with reference to the ultrasonic anemometer shown in FIG. 1 with only one measuring section, the invention is not limited to the use of ultrasonic anemometers with a certain number of measuring sections. Rather, it is conceivable to realize the invention with differently designed sonic or ultrasonic anemometers, in particular also with such ones having a plurality of differently oriented measuring sections.

The formation of a water layer on one of the two or on both sound transducers results in changes of the vibration behavior of the wetted sound transducer and thus of the measurement signal respectively generated in the receiving mode. Even the formation of a water layer on only one of the sound transducers can lead to a change in the frequencies of the measurement signals of both sound transducers. During precipitation, especially rain, these changes in frequency are step- or pulse-like. However, tests have shown that the changes in frequency do not only occur during precipitation events, but also during periods without precipitation. For this purpose, measurements were used to prove that changes in frequency caused by temperature fluctuations or evaporation of water layers on the sound transducers are comparatively slow or sluggish, resp., and can therefore be easily distinguished from the sudden, rain-induced changes in frequency. In contrast, rapid changes in frequency, which are presumably caused by turbulence, can pose a problem when evaluating the measurement signals generated by the sound transducers, as there is a risk that these rapid changes are confused with rain-induced changes in frequency. In order to be able to reliably detect the difference between precipitation-induced and, for example, turbulence-induced changes in frequency, according to the invention, not only the magnitude of a change in frequency, but also the type or the temporal response curve, resp., of the changes in frequency of the measurement signals generated by sound transducers arranged opposite one another in relation to a measuring section are evaluated. This takes into account the fact that the changes in frequency of the measurement signals generated by sound transducers arranged at both ends of a measuring section are synchronous in the case of precipitation-induced changes in frequency.

Since it was recognized that, in contrast, in the case of turbulence-induced changes in the frequencies of the measurement signals generated by sound transducers oppositely arranged in relation to a measuring section, the frequency response curves are different or even in opposite directions, this differentiation criterion is used according to the embodiment described here in order to realize a reliable detection of precipitation events.

The ultrasonic anemometer shown in FIG. 1 has two sound transducers, arranged at both ends of the measuring section, with a natural frequency f₀ of 58 KHz and a 3 dB bandwidth of about 6 kHz. The diameter of the acoustic membranes of the sound transducers is 14 mm and the angle of inclination of the acoustic membrane surface with respect to a horizontal plane is about 20°. The length of the measuring section extending between the two sound transducers is 150 mm, wherein measurements are performed at a frequency of 10 Hz. In this case, the sound transducers, in transmission mode, are each excited to oscillate with an approximately 10 us long pulse of 180 V via the piezo effect. The sound signal generated in this way impinges on the sound transducer on the opposite side of the measuring section, so that it is excited into a forced oscillation and generates an electrical measurement signal caused by the inverse piezo effect. This measurement signal is amplified and transmitted to an evaluation unit for further processing and evaluation via a data transmission path, which can be wireless or wired. Taking into account the measurement signals generated by the two sound transducers, the evaluation unit detects whether a precipitation event is present and generates and outputs a digital binary signal as the result signal, the respective value of which indicates, whether a precipitation event is present or not.

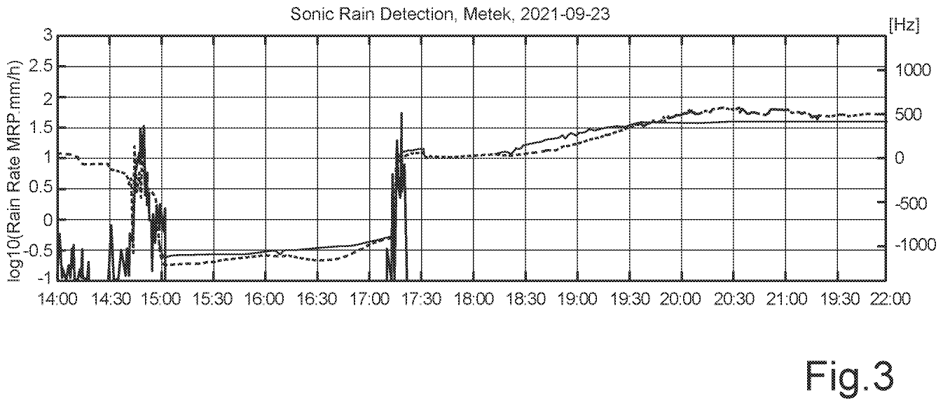

FIG. 2 shows an example for a measurement signal generated by the first, lower sound transducer S1. The frequency f₁ of the measurement signal is derived from the time of ten oscillation periods T. Furthermore, FIG. 3 shows the response curve of the frequencies of the measurement signals generated by the first, lower sound transducer S1 and by the second, upper sound transducer S2 over a period of 8 hours. According to the embodiment described here, two precipitation events in the form of rain showers occurred during this period, namely a first rain shower from 2:30 pm to 3:00 pm and a second rain shower from 5:15 pm to 5:20 pm.

A rain radar MRR-Pro of the company METEK GmbH with a temporal resolution of 10 s was used to validate the results obtained by means of the ultrasonic anemometer and the evaluation unit connected to it. The signal generated by means of the rain radar is also shown in FIG. 3.

First of all, it can be clearly seen that the measurement signals generated by the two sound transducers S1, S2 exhibit clear changes in frequency during the periods in which the rain radar, too, indicates the presence of a precipitation event. The measurement signals of both sound transducers S1, S2 show a step-like change in frequency of about 1 kHz during the rain shower, wherein the first rain shower leads to a decrease in frequency and the second rain shower to an increase in frequency of the measurement signals by about the same amount.

In this context, it is assumed that the frequency reduction during the first rain shower is due to the formation of a water layer on the first, lower sound transducer S1 or an attached droplet at the second, upper sound transducer. This increases the oscillating mass while the restoring forces remain approximately the same, which leads to a reduction in the resonant frequency. After the end of a rain shower, the frequencies of the measurement signals change only slightly, and it can be assumed that the slight increase in frequency is due to evaporation of the water layer. The second rain shower then leads to the water layer being washed off the surfaces of the sound transducers, so that the natural frequency returns to approximately its original value.

Since it appears difficult to reliably detect precipitation events on the basis of the response curve of the frequency of the measurement signals generated by the sound transducers, in particular on the basis of the response curve of the mean frequency, in the evaluation unit according to the invention, not the frequencies themselves, but the fine structures of their temporal changes are used to detect precipitation events. This evaluation is performed according to the preferred embodiment of the invention described below, taking into account the standard deviations of the frequencies of the measurement signals.

First, the selectivity of the detection of precipitation events is suitably increased in an evaluation unit by adding or averaging the changes in frequency at the first, lower sound transducer S1 as well as at the second, upper sound transducer. In this way, precipitation-induced components of a change in frequency are not reduced, while other, rapid changes are eliminated or at least attenuated due to the opposite nature of the change in frequency.

In order to ensure reliable precipitation detection, especially rain detection, the following signal processing is performed in the evaluation unit.

Here, the following applies:
σ(f₁) and (f₂): standard deviations of the frequencies generated by oppositely arranged sound transducers;
σₘ=σ((f₁+f₂)/2)): standard deviation of the mean frequencies;
σ_{d}=σ((f₁−f₂/2)): standard deviation of half the difference in frequencies;
q=σ_{d}/σ_{d}: quotient;
σᵣ=σₘ/(10·q+0.5): precipitation indicator.

Here, a value of 0.5 is added to the denominator in the calculation rule for determining the precipitation indicator in accordance with the embodiment described, in order to prevent division by zero (0). Based on the magnitude of the precipitation indicator, a result signal, in this case a binary signal, is ultimately generated, from which information can be extracted as to whether a precipitation event is present or not.

The individual standard deviations of the frequencies are determined using a sliding timeframe ws. In this way, slow changes in frequency, which extend over a period that is significantly longer than the sliding timeframe ws, are suppressed. These slow changes in frequency are caused, for example, by temperature changes or by a stationary water layer at the end of a rain event and the evaporation resulting herefrom. Due to the chosen procedure, an independent sample is only available after the period of time defined for the duration of the sliding timeframe ws has elapsed. Thus, the length of the sliding timeframe determines the temporal resolution of the measurement. According to the embodiment described here, the length of the sliding timeframe ws is 50 s.

The time period, in which the frequencies of the measurement signals change due to precipitation, is so long that the temporal resolutions usually available with the known ultrasonic anemometers are entirely sufficient for the measurements made for precipitation detection and are not required in full.

Furthermore, in order to reduce measured value noise, the frequencies of the measurement signals of the two sound transducers are averaged or the median value is determined, resp., via a sliding averaging timeframe wm before calculating their standard deviations σ(f1), σ(f2). According to the embodiment described here, a timespan of 50 s was likewise selected for the length of the averaging period.

Due to the use of the previously described timeframe ws and the averaging timeframe wm, a bandpass filter with the center frequency f_{mB}=2/(wm+ws) is defined.

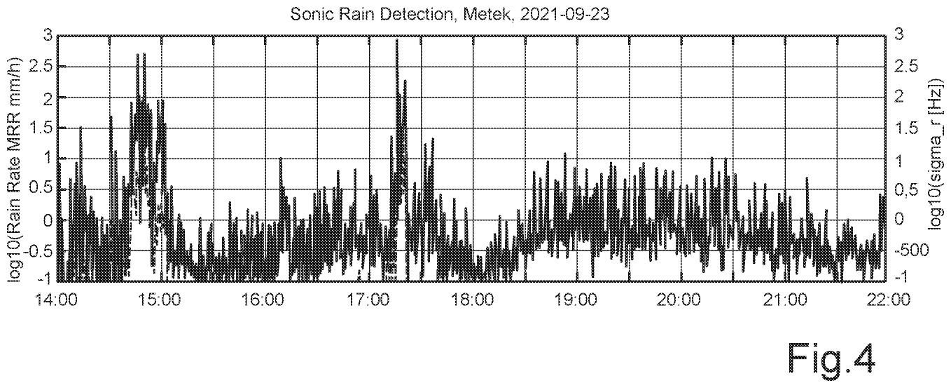

In addition to FIG. 3, FIG. 4 shows the temporal progression of the values of the precipitation indicator determined in the evaluation unit together with the rain rate, which was recorded by means of the above-mentioned rain radar. Finally, a stable binary signal with the values 1=precipitation event and 0=no precipitation event is generated on the basis of the precipitation indicator values determined. The evaluations performed according to the described embodiment have shown that the definition of a limit value, at which the presence of a precipitation event is recognized, appears to be suitable, which lies in a range of 10 to 50 Hz. The definition of a limit value that lies in a range between 15 and 25 Hz appears to be particularly suitable.

Detailed tests have shown that there may be individual exceedances of the limit value despite the filter measures described above. For this reason, it is checked during the evaluation, whether further limit value exceedances occur in the vicinity of the limit value exceedances determined. For this purpose, an ambient interval of 1 minute is defined in the evaluation unit. For the measurement sequence of 10 Hz selected in accordance with the embodiment described, this means that this ambient interval has 600 measured values. With regard to a measuring point, the presence of a precipitation event is furthermore only still concluded, if a defined percentage, preferably 50%, of the surrounding measurements likewise comes to the conclusion that a precipitation event is present.

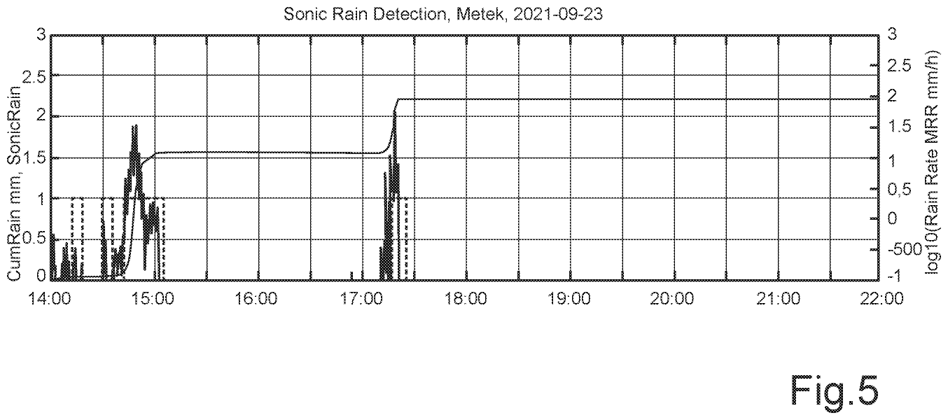

The binary time series generated in this way shows frequent interruptions in the case of precipitation events, which is due to the inevitably stochastic nature of the measurement signal. Due to the comparatively small surface area of the sound transducers, which is less than 1 cm², it is either hit by a precipitation particle, in particular a raindrop during a rain shower, or not. For this reason, it is provided that the information about a detected precipitation event is stored in a memory in the evaluation unit for a storage period that is set to 5 minutes. A binary time series determined in this way is shown in FIG. 5. In addition, the rain intensity as well as the temporal integral of this function, i.e. the cumulative amount of rain determined with the above-mentioned rain radar, are shown. This gives a clear impression of the respective rain event. As the representation shows, 1.5 mm of precipitation fell during the first rain shower detected according to the invention, and 5 mm during the second rain shower. The evaluation in FIG. 5 illustrates that both rain events were clearly detected. The two short detections before the first rain shower in a period from 2:10 pm to 2:30 pm are also correlated with rain, which was, however, very weak and only resulted in a cumulative amount of rain of less than 0.1 mm.

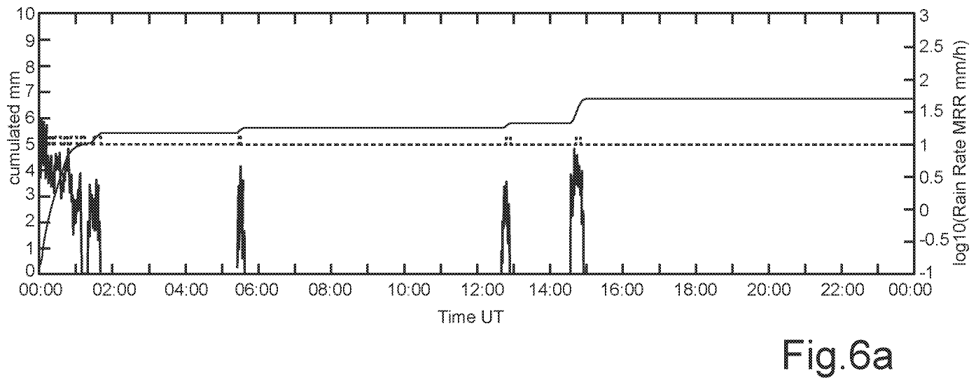

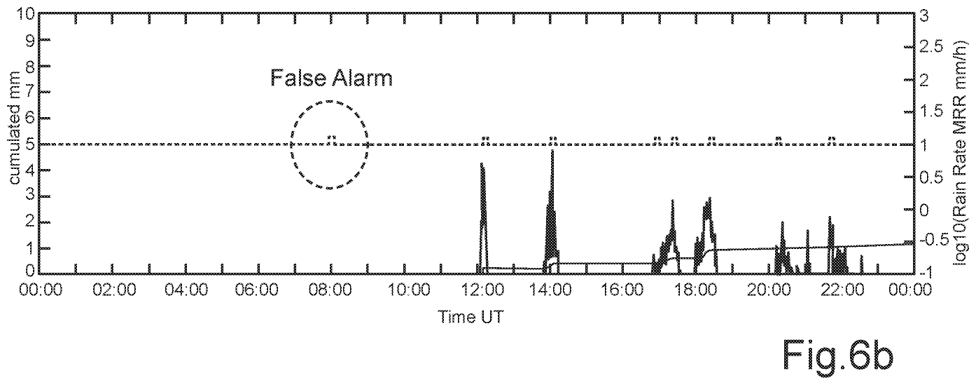

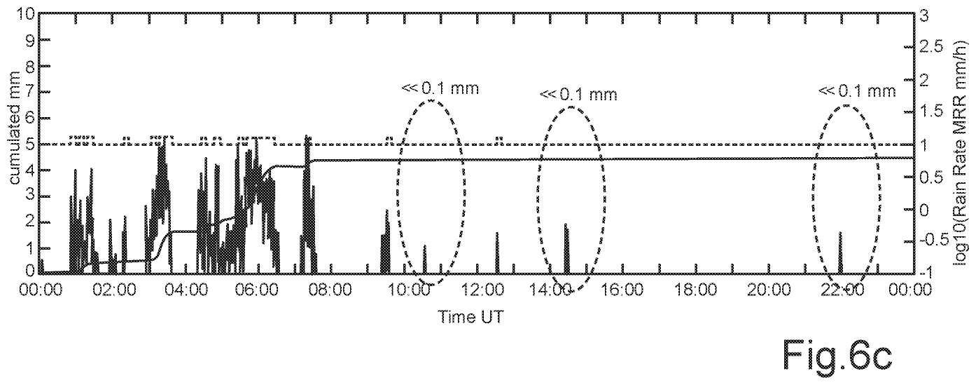

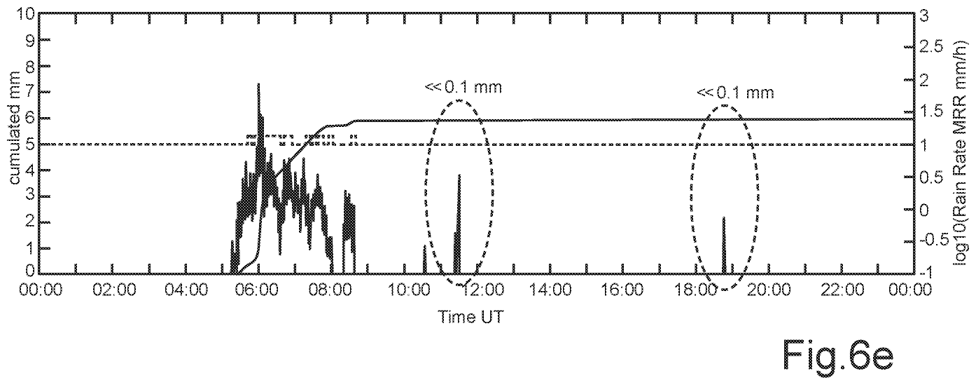

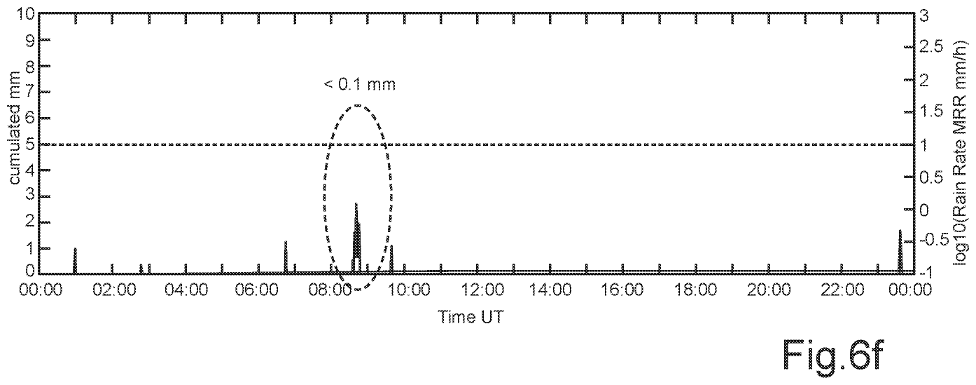

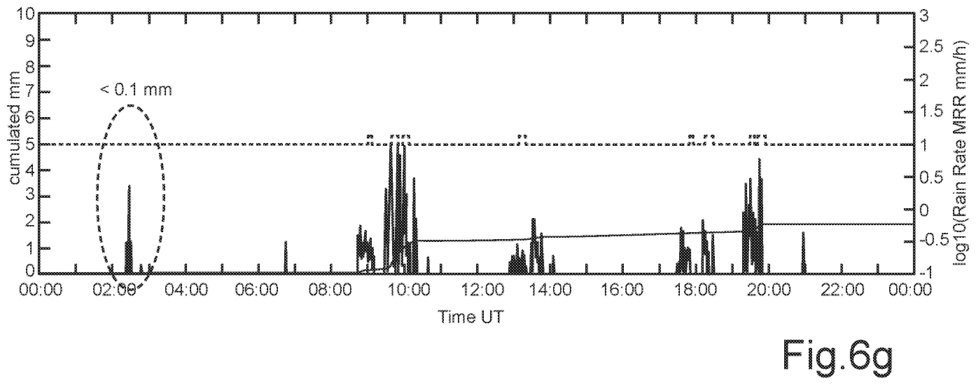

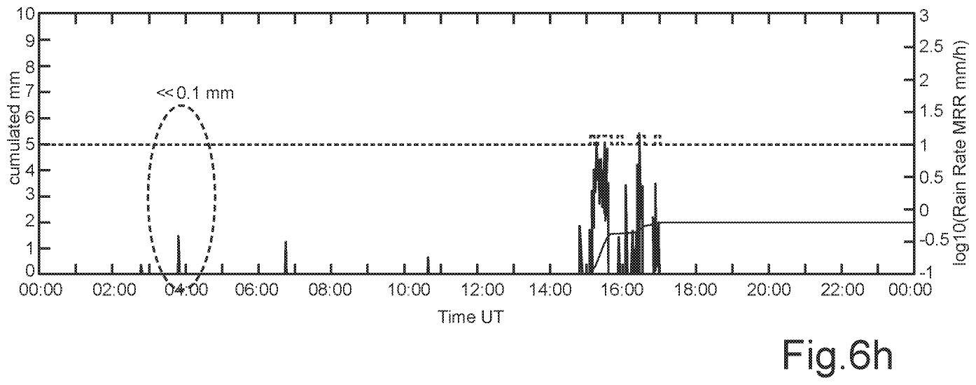

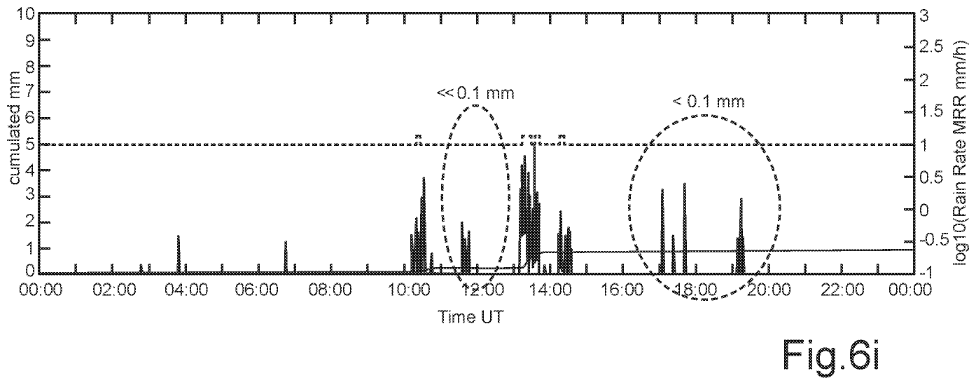

In addition, FIG. 6 contains the same information as FIG. 5 in the representations 6a) to 6i), namely the binary signal indicating the detected precipitation results as well as the rain intensity and amount of rain recorded with the rain radar. The measurements were performed over an observation period of 8×24 hours, during which rain events with a cumulative amount of rain totaling 23 mm were observed. It can be clearly seen in the representations in FIG. 6 that precipitation events with a cumulative amount of rain greater than 0.1 mm were reliably detected. Only FIG. 6b) shows a precipitation detection, although it was not raining. Insofar as precipitation events were not detected, they were rain showers with a cumulative amount of rain of less than 0.1 mm.

1. A method for recording precipitation events, in which two sound transducers arranged on opposite sides of a measuring section each alternately emit ultrasonic waves during a transmission period at least in certain areas along the measuring section in such a way that, in a first transmission period, a first of the sound transducers emits ultrasonic waves, while the opposite second sound transducer at least partially receives the emitted ultrasonic waves, and, in at least one second transmission period, the second sound transducer emits ultrasonic waves, while the first sound transducer at least partially receives the emitted ultrasonic waves, wherein the sound transducers each generate a measurement signal during receipt of the ultrasonic waves depending on a property of the received ultrasonic waves, and in which the measurement signals generated by the sound transducers are transmitted, via a data transmission path, to an evaluation unit, which generates information about at least one atmospheric parameter on the basis of a property of the measurement signals,
characterized in that the evaluation unit detects and evaluates changes in the frequency of the measurement signals transmitted by the sound transducers, records a magnitude and a response curve of the frequencies during the changes in frequency and, depending on the magnitude of the changes in frequency as well as a comparison of the frequency response curves during the change in frequency, detects a precipitation event and outputs information about the occurrence of the precipitation event.

2. The method according to claim 1,
characterized in that, upon evaluation of the measurement signals, the occurrence of a precipitation event is detected, if a limit value defined for the magnitude of the changes in frequency is exceeded and the response curves of the changes in frequency of the measurement signals generated by the opposite sound transducers are identical, synchronous and/or mean gradients of the response curves of the changes in frequency are identical.

3. The method according to claim 1,
characterized in that, upon evaluation of the measurement signals, the frequencies of the measurement signals generated by the opposite sound transducers in a measuring period are at least temporarily added and/or mean values are formed therefrom.

4. The method according to claim 3,
characterized in that the mean values of the recorded frequencies of the measurement signals are formed over an averaging period (wₘ), which preferably is 50 s.

5. The method according to claim 1,
characterized in that, upon evaluation of the measurement signals,
from the frequencies of the measurement signals generated by opposite sound transducers, at least two standard deviations,
a standard deviation σₘ of the mean frequency of the measurement signals generated by opposite sound transducers,
a standard deviation od of half the difference in frequencies,
a quotient q formed from σ_{d} and σₘ, and
a precipitation indicator σᵣ determined taking into account the standard deviation σₘ as well as the aforementioned quotient q, in particular by quotient formation,
are formed.

6. The method according to claim 5,
characterized in that an exceedance of a threshold value for the rain indicator is used to decide whether a precipitation event is present.

7. The method according to claim 5 or 6,
characterized in that a decision is made as to the presence of a precipitation event, if a value for the rain indicator exceeds a threshold value of 10 to 70 Hz, in particular 60 Hz.

8. The method according to claim 7,
characterized in that it is checked in a measuring interval, how often the rain indicator is above the threshold value, and, as soon as more than half of the measurements performed in the measuring interval show that the rain indicator is above the threshold value, it is concluded that a precipitation event is present.

9. The method according to claim 5,
characterized in that the standard deviations are determined in relation to a defined period of time (wₛ), which preferably is 50 s.

10. The method according to claim 8,
characterized in that 600 measurements are performed in a measuring interval of one minute.

11. The method according to claim 1,
characterized in that the information about the presence of the precipitation event is stored in a memory and/or output over a period of 3 to 6 minutes, preferably for about 5 minutes, from detection of the precipitation event.

12. A device for recording precipitation events having at least two sound transducers, between which a measuring section extends and of which respectively one sound transducer is alternately adapted to emit ultrasonic waves along the measuring section, while the opposite sound transducer is adapted to generate a measurement signal, which is specific for the ultrasonic waves impinging after propagation along the measuring section, and having an evaluation unit, which is connected to the sound transducers via a signal transmission path and generates information about at least one atmospheric parameter on the basis of a frequency of the at least one measurement signal, characterized in that the evaluation unit is adapted to detect a precipitation event on the basis of a change in the frequencies of the measurement signals generated by the opposite sound transducers, taking into account a magnitude of the changes in frequency of the measurement signals and a comparison of the frequency response curves of the measurement signals generated during the change in frequency.

13. The device according to claim 12,
characterized in that the evaluation unit is adapted to detect the occurrence of a precipitation event, if a limit value defined for the magnitude of the changes in frequency is exceeded and the response curves of the changes in frequency of the measurement signals generated by the opposite sound transducers are identical, synchronous and/or mean gradients of the response curves of the changes in frequency are identical.

14. The device according to claim 13,
characterized in that the limit value taken into account in the evaluation unit for the magnitude of the change in frequency is greater than 800 Hz, preferably greater than 1 KHz.

15. The device according to claim 12,
characterized in that the sound transducers are designed as piezo sound transducers with a natural frequency of 58 KHz and a 3 dB bandwidth of about 6 KHz.
